(19) United States
(12) Patent Application Publication
(10) Pub. No.: US 2010/0106850 A1
(43) Pub. Date: Apr. 29, 2010

(54) STREAM PROCESSING METHOD AND SYSTEM

(75) Inventors: You-Ming Tsao, Taipei City (TW); Liang-Gee Chen, Taipei (TW); Shao-Yi Chien, Taipei (TW)

Correspondence Address: OCCHIUTI ROHLICEK & TSAO, LLP, 10 FAWCETT STREET, CAMBRIDGE, MA, 02138, US

(73) Assignee: National Taiwan University, Taipei (TW)

(21) Appl. No.: 12/436,008

(22) Filed: May 5, 2009

(30) Foreign Application Priority Data
Oct. 24, 2008 (TW) 097140968

(51) Int. Cl. G06F 15/173

(52) U.S. Cl. 709/231

(57) ABSTRACT

In a stream processing method and system, each of a plurality of stream elements stored in a previous-stage module is configured with a specific index value. Each stream element includes a group of stream data. A stream fetching module fetches from the previous-stage module the stream elements in sequence such that the index values of the fetched stream elements correspond to a sequence of predetermined index values associated with a desired stream fetching pattern, and provides in sequence the stream elements fetched thereby to a post-stage module.

### CROSS-REFERENCE TO RELATED APPLICATION

This application claims priority of Taiwanese Application No. 097140968, filed on Oct. 24, 2008.

### BACKGROUND OF THE INVENTION

1. Field of the Invention

The invention relates to a digital signal processing method and system, more particularly to a stream processing method and system.

2. Description of the Related Art

A conventional multi-core processor having a micro architecture encounters data transmission congestion as a result of poor stream data access efficiency, thereby adversely affecting performance thereof.

### SUMMARY OF THE INVENTION

Therefore, an object of the present invention is to provide a stream processing method and system that can effectively enhance stream data access efficiency in a multi-core stream processing system.

According to one aspect of the present invention, a stream processing system comprises:

a previous-stage module storing a plurality of stream elements each including a group of stream data, each of the stream elements being configured with a specific index value;

a post-stage module; and

a stream fetching module coupled to the previous-stage module and the post-stage module, the stream fetching module being operable to fetch from the previous-stage module the stream elements in sequence such that the index values of the fetched stream elements correspond to a sequence of predetermined index values associated with a desired stream fetching pattern, and providing in sequence the stream elements fetched thereby to the post-stage module.

According to another aspect of the present invention, a stream processing method comprises the steps of:

a) configuring each of a plurality of stream elements stored in a previous-stage module with a specific index value, each of the stream elements including a group of stream data;

b) fetching from the previous-stage module the stream elements in sequence such that the index values of the fetched stream elements correspond to a sequence of predetermined index values associated with a desired stream fetching pattern; and

c) providing in sequence the stream elements fetched in step b) to a post-stage module.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram illustrating the preferred embodiment of a stream processing system according to the present invention;

FIG. 2 is a schematic circuit block diagram illustrating a stream processing module and two stream fetching modules of the preferred embodiment;

FIG. 3 is a flow chart illustrating a stream processing method performed by the stream processing system of the preferred embodiment; and

FIGS. 4 to 6 illustrate different stream fetching patterns suitable for use in the preferred embodiment.

### DETAILED DESCRIPTION OF THE PREFERRED EMBODIMENT

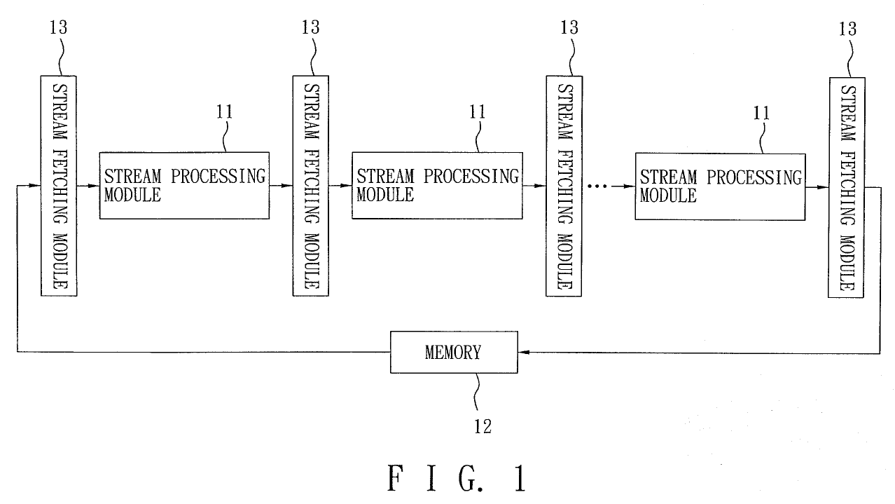

Referring to FIG. 1, the preferred embodiment of a stream processing system, such as a multi-core stream processing system, according to the present invention is shown to include a memory 12, a number (N) of stream processing modules 11, and a number (N+1) of stream fetching modules 13, wherein the memory 12 is coupled between first and (N+1)^{th} ones of the stream fetching modules 13 and a P^{th} one of the stream processing modules 11 is coupled between P^{th} and (P+1)^{th} ones of the stream fetching modules 13, where 1≦P≦N, such that the memory 12, the stream processing modules 11 and the stream fetching modules 13 form a circuit loop. For the first one of the stream fetching modules 13, the memory 12 serves as a previous-stage module, and a first one of the stream processing modules 11 serves as a post-stage module. For a P^{th} one of the stream fetching modules 13, where 2≦P≦N, a (P−1)^{th} one of the stream processing modules 11 serves as a previous-stage module, and the P^{th} one of the stream processing modules 11 serves as a post-stage module. For the (N+1)^{th} one of the stream fetching modules 13, the N^{th} one of the stream processing modules 11 serves as a previous-stage module, and the memory 12 serves as a post-stage module.

The memory 12 is a frame buffer memory for storing frame data in this embodiment. The frame data can be divided to form a plurality of stream elements each including a group of stream data. It is noted that the stream elements may overlap each other. Furthermore, if the stream processing system is applied in a video coding system, each stream element can be a macroblock. If the stream processing system of the preferred embodiment is applied in an audio coding system, each stream element can be data of a filter window. If the stream processing system is applied for graphic processing, each stream element can be data of a corresponding one of vertexes of a graphic polygon object.

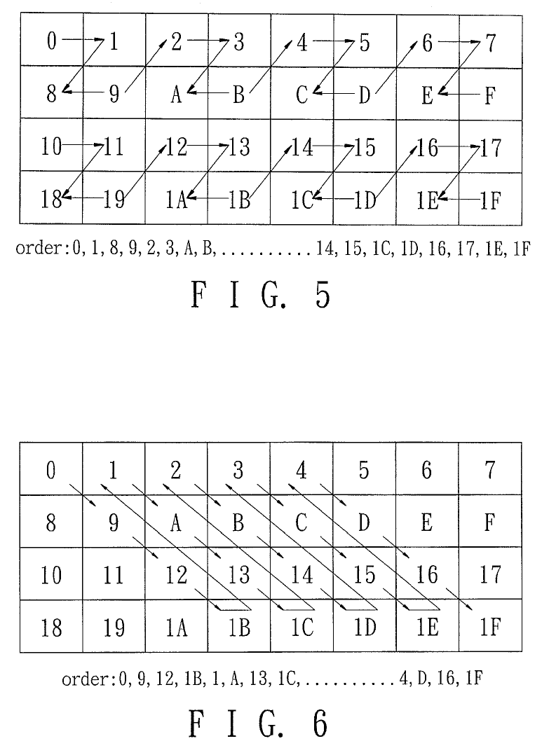

The first one of the stream fetching modules 13 is operable to fetch from the memory 12 a predetermined number of the stream elements, each configured with a specific index value, in sequence such that the index values of the fetched stream elements correspond to a sequence of predetermined index values associated with a desired stream fetching pattern, and provides in sequence the stream elements fetched thereby to the first one of the stream processing modules 11. It is noted that the predetermined number of the stream elements comes from a part of the frame data. In other embodiments, the predetermined number of the stream elements is the whole of the frame data. It is noted that the desired stream fetching pattern is programmable, as shown in FIGS. 4 to 6.

Similarly, the P^{th} one of the stream fetching modules 13 fetches from the (P−1)^{th} one of the stream processing modules 11 a plurality of stream elements in sequence, and provides in sequence the stream elements fetched thereby to the P^{th} one of the stream processing modules 11, where 2≦P≦N. The (N+1)^{th} one of the stream fetching modules 13 fetches from the N^{th} one of the stream processing modules 11 a plurality of stream elements in sequence, and stores the stream elements fetched thereby in the memory 12.

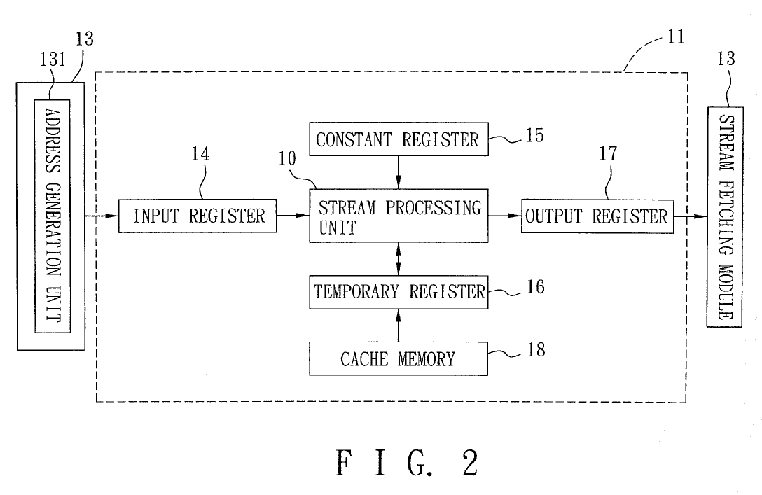

Each stream fetching module 13 includes an address generation unit 131 (see FIG. 2) for generating addresses corresponding to the stream elements to be fetched based on the desired stream fetching pattern such that each stream fetching module 13 fetches from the previous-stage module the stream elements in sequence according to the addresses generated by the address generation unit 131.

Referring to FIG. 2, each of the stream processing modules 11 is shown to include an input register 14, an output register 17, a constant register 15, a temporary register 16, a stream processing unit 10, and a cache memory 18.

For the P^{th} one of the stream processing modules 11, where 1≦P≦N, the input register 14 is coupled to the P^{th} one of the stream fetching modules 13 for receiving and storing the stream elements provided thereby, and the output register 17 is coupled to the (P+1)^{th} one of the stream fetching modules 13.

For each stream processing module 11, the constant register 15 stores constant reference values. The temporary register 16 stores dynamic data during stream processing. The cache memory 18 is coupled to the temporary register 16, and stores required data during stream processing to minimize number of data accesses. The stream processing unit 10 is coupled to the input register 14, the output register 17, the constant register 15 and the temporary register 16. The stream processing unit 10 is operable to perform in sequence processing of the stream elements stored in the input register 14 using the constant reference values stored in the constant register 15, the dynamic data stored in the temporary register 16, and the required data stored in the cache memory 18 to obtain a processing result, and stores the processing result in the output register 17. It is noted that, for the P^{th} one of the stream processing modules 11, the processing result stored in the output register 17 includes the plurality of the stream elements fetched by the (P+1)^{th} one of the stream fetching modules 13.

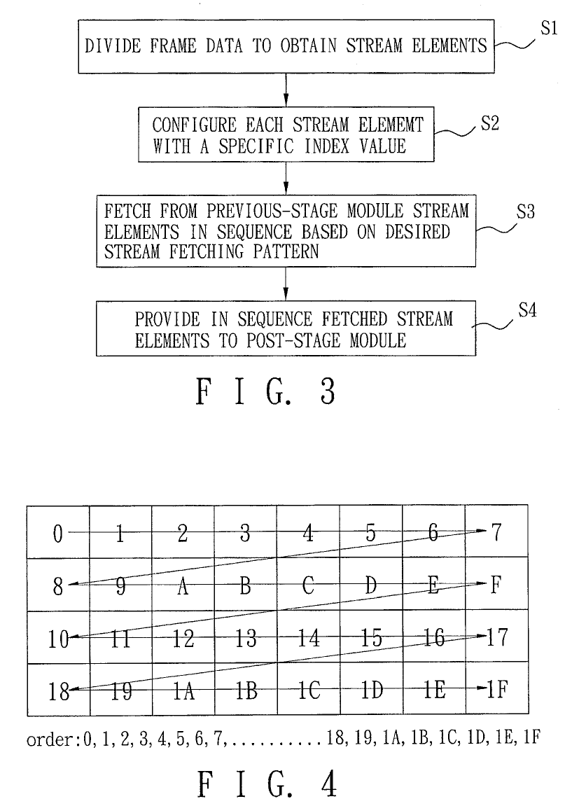

FIG. 3 is a flow chart illustrating a stream processing method performed by the stream processing system of the preferred embodiment.

In step S1, the frame data stored in the memory 12 is divided to obtain the predetermined number of the stream elements.

In step S2, each of the stream elements obtained in step S1 is configured with the specific index value.

In step S3, each of the stream fetching modules 13 fetches from a corresponding previous-stage module the stream elements in sequence such that the index values of the fetched stream elements correspond to the sequence of the predetermined index values associated with the desired stream fetching pattern. For the first one of the stream fetching modules 13, the corresponding previous-stage module is the memory 12. For the P^{th} one of the stream fetching modules 13, where 2≦P≦N+1, the corresponding previous-stage is the (P−1)^{th} one of the stream processing modules 11.

In step S4, each of the stream fetching modules 13 provides in sequence the stream elements fetched in step S3 to a corresponding post-stage module. For the P^{th} one of the stream fetching modules 13, where 1≦P≦N, the corresponding post-stage module is the P^{th} one of the stream processing modules 11. For the (N+1)^{th} one of the stream fetching modules 13, the post-stage module is the memory 12.

In sum, the stream processing system of the present invention can be configured as a macro pipeline architecture. Each stream processing module 11 is regarded as a pipeline stage and is coupled in series to a pipeline previous-stage and a pipeline post-stage via the corresponding pair of the stream fetching modules 13, respectively. Furthermore, due to the configuration of the index values for the stream elements and the utilization of the programmable stream fetching pattern, stream data access efficiency of the stream processing system of the present invention can be effectively enhanced.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A stream processing system comprising:
a previous-stage module storing a plurality of stream elements each including a group of stream data, each of the stream elements being configured with a specific index value;
a post-stage module; and
a stream fetching module coupled to said previous-stage module and said post-stage module, said stream fetching module being operable to fetch from said previous-stage module the stream elements in sequence such that the index values of the fetched stream elements correspond to a sequence of predetermined index values associated with a desired stream fetching pattern, and providing in sequence the stream elements fetched thereby to said post-stage module.

2. The stream processing system as claimed in claim 1, wherein said previous-stage module includes a stream processing module, and said post-stage module includes a memory.

3. The stream processing system as claimed in claim 1, wherein said previous-stage module includes one of a memory and a stream processing module, and said post-stage module includes a stream processing module.

4. The stream processing system as claimed in claim 3, wherein said stream processing module includes:
an input register coupled to said stream fetching module for receiving and storing the stream elements;
an output register;
a constant register for storing constant reference values;
a temporary register for storing dynamic data during stream processing; and
a stream processing unit coupled to said input register, said output register, said constant register and said temporary register, said stream processing unit being operable to perform in sequence processing of the stream elements stored in said input register using the constant reference values stored in said constant register and the dynamic data stored in said temporary register to obtain a processing result corresponding to the stream elements, and storing the processing result in said output register.

5. The stream processing system as claimed in claim 4, wherein said stream processing module further includes a cache memory coupled to said temporary register.

6. The stream processing system as claimed in claim 1, wherein said stream fetching module includes an address generation unit for generating addresses corresponding to the stream elements to be fetched based on the desired stream fetching pattern such that said stream fetching module fetches from said previous-stage module the stream elements in sequence according to the addresses generated by said address generation unit.

7. A stream processing method comprising the steps of:
a) configuring each of a plurality of stream elements stored in a previous-stage module with a specific index value, each of the stream elements including a group of stream data;
b) fetching from the previous-stage module the stream elements in sequence such that the index values of the fetched stream elements correspond to a sequence of predetermined index values associated with a desired stream fetching pattern; and
c) providing in sequence the stream elements fetched in step b) to a post-stage module.

8. The stream processing method as claimed in claim 7, wherein step b) further includes the sub-steps of:
b-1) generating addresses corresponding to the stream elements to be fetched based on the desired stream fetching pattern; and
b-2) fetching from the previous-stage module the stream elements in sequence according to the addresses generated in step b-1).

9. The stream processing method as claimed in claim 7, the previous-stage module including a memory for storing frame data therein, said stream processing method further comprising, prior to step a), the step of:
a0) dividing the frame data to obtain the plurality of the stream elements.

10. The stream processing method as claimed in claim 9, wherein the plurality of the stream elements obtained in step a0) are divided from a part of the frame data.

11. The stream processing method as claimed in claim 9, wherein the plurality of the stream elements obtained in step a0) are divided from the whole of the frame data.

12. The stream processing method as claimed in claim 11, wherein the stream elements overlap each other.
